(19) United States
(12) Patent Application Publication
(10) Pub. No.: US 2025/0278231 A1
(43) Pub. Date: Sep. 4, 2025

(54) Data Display Method and System, and Electronic Device

(71) Applicant: Huawei Technologies Co., Ltd., Shenzhen (CN)

(72) Inventors: Rong Wang, Shanghai (CN); Zichen Xie, Shanghai (CN); Jingjing Yao, Shanghai (CN)

(21) Appl. No.: 19/210,312

(22) Filed: May 16, 2025

Related U.S. Application Data
(63) Continuation of application No. PCT/CN2023/128078, filed on Oct. 31, 2023.

(30) Foreign Application Priority Data
Nov. 18, 2022 (CN) 202211446399.7

(51) Int. Cl. G06F 3/14; G06F 3/0354; G06F 3/038

(52) U.S. Cl. CPC G06F 3/1423; G06F 3/03543; G06F 3/038; G06F 2203/0384

(57) ABSTRACT

An input device sends first sending data to a plurality of host devices, where first input device data in the first sending data is used to enable a focus host device to display a target image, the target image moves along with movement of the input device. The input device further sends second sending data to the plurality of host devices when the target image moves across a first screen edge that is of the focus host device and that is close to a next focus host device, where second input device data in the second sending data is used to enable the next focus host device to display the target image, and the next focus host device is a focus host device among the plurality of host devices that is close to the first screen edge of the focus host device.

### CROSS-REFERENCE TO RELATED APPLICATIONS

This is a continuation of Int'l Patent App. No. PCT/CN2023/128078 filed on Oct. 31, 2023, which claims priority to Chinese Patent Application No. 202211446399.7 filed on Nov. 18, 2022, both of which are incorporated by reference.

### TECHNICAL FIELD

The present disclosure relates to the field of computer technologies, and in particular, to a data display method and system, and an electronic device.

### BACKGROUND

Currently, multi-screen office and entertainment scenarios are increasingly common. A single input device (for example, a wireless BLUETOOTH mouse) may need to control a plurality of host devices (for example, screen devices) and switch back and forth between different host devices. However, the input device can be connected to only one host device at a time. During switching, link disconnection and establishment are required, resulting in a longer switching delay.

### SUMMARY

In view of this, embodiments of the present disclosure provide a data display method and system, and an electronic device. An input device keeps connected to a plurality of host devices at the same time, and link disconnection and establishment are not required, thereby reducing a switching delay.

According to a first aspect, an embodiment of the present disclosure provides a data display method, applied to an input device. The input device is wirelessly connected to a plurality of host devices, and the plurality of host devices are wirelessly connected to each other. The method includes sending first sending data to the plurality of host devices, where the first sending data includes first input device data, the first input device data is used to enable a focus host device to display a target image, the target image moves along with movement of the input device, and the focus host device is a host device among the plurality of host devices that currently displays the target image. The method further includes sending second sending data to the plurality of host devices when the target image moves across a first screen edge of the focus host device, and the first screen edge is close to a next focus host device, where the second sending data includes second input device data, the second input device data is used to enable the next focus host device to display the target image, and the next focus host device is a focus host device among the plurality of host devices that is close to the first screen edge of the focus host device. In this embodiment of the present disclosure, the input device keeps connected to the plurality of host devices at the same time, and when the input device switches back and forth between different host devices, link disconnection and establishment are not required, thereby reducing a switching delay.

With reference to the first aspect, in some implementations of the first aspect, there are wireless connections of a plurality of one-to-one links between the input device and the plurality of host devices. In this embodiment of the present disclosure, the input device may keep connected to the plurality of host devices at the same time through the wireless connections of the plurality of one-to-one links, and the input device may independently interact with each of the plurality of host devices.

With reference to the first aspect, in some implementations of the first aspect, a link between the input device and the focus host device is in an active state, and a link between the input device and a non-focus host device is in a keepalive state. In this embodiment of the present disclosure, when there are wireless connections of a plurality of one-to-one links between the input device and the plurality of host devices, only a one-to-one link between the input device and the focus host device is in the active state, and all one-to-one links between the input device and the rest of non-focus host devices are in the keepalive state.

With reference to the first aspect, in some implementations of the first aspect, the first sending data further includes null packet data; and the sending first sending data to the plurality of host devices includes sending the first input device data to the focus host device, and sending the null packet data to the non-focus host device. The sending second sending data to the plurality of host devices includes sending the second input device data to the next focus host device, and sending the null packet data to the rest of the host devices. In this embodiment of the present disclosure, when there are wireless connections of a plurality of one-to-one links between the input device and the plurality of host devices, only the focus host device can receive the first input device data, to display the target image corresponding to the first input device data. The rest of non-focus host devices can receive only the null packet data, and skip displaying the target image. After the next focus host device is switched to for displaying the target image, only the next focus host device can receive the second input device data, to display the target image corresponding to the second input device data. The rest of non-next focus host devices can receive only null packet data, and skip displaying the target image.

With reference to the first aspect, in some implementations of the first aspect, before the sending first sending data to the plurality of host devices, the method further includes allocating a first air interface slot to a host device that is the first to establish a connection to the input device, and allocating air interface slots to the rest of the host devices based on the first air interface slot. In this embodiment of the present disclosure, when there are wireless connections of a plurality of one-to-one links between the input device and the plurality of host devices, the input device may serve as a master node to allocate air interface slots to the plurality of host devices.

With reference to the first aspect, in some implementations of the first aspect, the sending first sending data to the plurality of host devices includes sending, based on an air interface slot allocated by a host device that is the first to establish a connection to the input device, data to the host device that is the first to establish a connection to the input device, and sending data to the rest of the host devices based on air interface slots allocated to the rest of the host devices by the host device that is the first to establish a connection to the input device. In this embodiment of the present disclosure, when there are wireless connections of a plurality of one-to-one links between the input device and the plurality of host devices, the host device that is the first to establish a connection to the input device may serve as a master node to allocate an air interface slot to each host device.

With reference to the first aspect, in some implementations of the first aspect, air interface slots for the plurality of host devices are different from each other. In this embodiment of the present disclosure, an air interface slot for a one-to-one link between each host device and the input device is different from each other, thereby avoiding a slot conflict of the plurality of one-to-one links.

With reference to the first aspect, in some implementations of the first aspect, when the target image moves across the first screen edge of the focus host device, before the sending second sending data to the plurality of host devices, the method further includes receiving an activation message sent by the next focus host device, and switching, based on the activation message, a link between the input device and the next focus host device from the keepalive state to the active state, and the link between the input device and the focus host device from the active state to the keepalive state. In this embodiment of the present disclosure, when there are wireless connections of a plurality of one-to-one links between the input device and the plurality of host devices, a next focus host sends a packet to the input device to activate a link.

With reference to the first aspect, in some implementations of the first aspect, the wireless connections of the plurality of one-to-one links include BLUETOOTH. In this embodiment of the present disclosure, BLUETOOTH may be used to implement the wireless connections of the plurality of one-to-one links between the input device and the plurality of host devices.

With reference to the first aspect, in some implementations of the first aspect, there is a wireless connection of a one-to-many link between the input device and the plurality of host devices. In this embodiment of the present disclosure, the input device may keep connected to the plurality of host devices at the same time through the wireless connection of the one-to-many link. There is no delay caused by time-division switching of a link on the one-to-many link, and there is no slot conflict between the plurality of one-to-one links. In this case, a data transmission delay is lower than a delay in the case of the plurality of one-to-one links, and scalability in a multi-screen case is better than scalability in the case of the plurality of one-to-one links.

With reference to the first aspect, in some implementations of the first aspect, the sending first sending data to the plurality of host devices includes sending the first input device data to both the focus host device and a non-focus host device. In this embodiment of the present disclosure, there is a wireless connection of a one-to-many link between the input device and the plurality of host devices. The input device sends the first sending data to the plurality of host devices at the same time, where the first sending data is the first input device data, and the plurality of host devices receive the first input device data at the same time. When the target image moves between screens of the plurality of host devices, only a screen to which the target image moves displays the target image; or otherwise, the target image is not displayed.

With reference to the first aspect, in some implementations of the first aspect, before the sending first sending data to the plurality of host devices, the method further includes selecting one host device from the plurality of host devices as a first focus host device. In this embodiment of the present disclosure, there is a wireless connection of a one-to-many link between the input device and the plurality of host devices. During initialization, the input device selects, randomly or by default, one host device from the plurality of host devices as a first focus host device.

With reference to the first aspect, in some implementations of the first aspect, the wireless connection of the one-to-many link includes BLUETOOTH or SPARKLINK. In this embodiment of the present disclosure, BLUETOOTH or SPARKLINK may be used to implement the wireless connection of the one-to-many link between the input device and the plurality of host devices.

With reference to the first aspect, in some implementations of the first aspect, the input device includes a mouse, a touchpad, a trackball, or an eye recognition apparatus.

According to a second aspect, an embodiment of the present disclosure provides a data display method, applied to a host device. The host device is wirelessly connected to at least one other host device, both the host device and the other host device are wirelessly connected to an input device, and the method includes receiving first receiving data sent by the input device, and determining, based on the first receiving data and a screen position relationship between the host device and the at least one other host device, that the host device is a focus host device, and displaying a target image, where the focus host device is a host device among a plurality of host devices that currently displays the target image, and the target image moves along with movement of the input device. The method further includes sending a switching instruction to a next focus host device based on the screen position relationship when the target image moves across a first screen edge of the host device, and the first screen edge is close to the next focus host device, where the switching instruction is used to switch to the next focus host device to display the target image, and the next focus host device is a host device that is among the at least one other host device and that is close to the first screen edge of the host device, and receiving second receiving data sent by the input device, determining, based on the second receiving data and the screen position relationship, that the host device is a non-next focus host device, and skipping displaying the target image. In this embodiment of the present disclosure, the input device keeps connected to the plurality of host devices at the same time, and when the input device switches back and forth between different host devices, link disconnection and establishment are not required, thereby reducing a switching delay.

With reference to the second aspect, in some implementations of the second aspect, the method further includes determining, based on the first receiving data and the screen position relationship, that the host device is a non-focus host device, and skipping displaying the target image. The focus host device is a host device that is among the at least one other host device and that currently displays the target image. In this embodiment of the present disclosure, only the focus host device displays the target image, and the non-focus host skips displaying the target image. In addition, there can be only one focus host device among the plurality of host devices at the same time.

With reference to the second aspect, in some implementations of the second aspect, there are wireless connections of a plurality of one-to-one links between the input device and the host device and the at least one other host device. In this embodiment of the present disclosure, the input device may keep connected to the plurality of host devices at the same time through the wireless connections of the plurality of one-to-one links, and the input device may independently interact with each of the plurality of host devices.

With reference to the second aspect, in some implementations of the second aspect, a link between the input device and the focus host device is in an active state, and a link between the input device and a non-focus host device is in a keepalive state. In this embodiment of the present disclosure, when there are wireless connections of a plurality of one-to-one links between the input device and the plurality of host devices, only a one-to-one link between the input device and the focus host device is in the active state, and all one-to-one links between the input device and the rest of non-focus host devices are in the keepalive state. With reference to the second aspect, in some implementations of the second aspect, when the host device is the focus host device, the first receiving data is first input device data, and the second receiving data is null packet data; when the host device is the non-focus host device, the first receiving data is the null packet data; and when the host device is the next focus host device, the second receiving data is second input device data. In this embodiment of the present disclosure, when there are wireless connections of a plurality of one-to-one links between the input device and the plurality of host devices, only the focus host device can receive the first input device data, to display the target image corresponding to the first input device data. The rest of non-focus host devices can receive only the null packet data, and skip displaying the target image. After the input device switches to the next focus host device to display the target image, only the next focus host device can receive the second input device data, to display the target image corresponding to the second input device data. The rest of non-next focus host devices can receive only null packet data, and skip displaying the target image.

With reference to the second aspect, in some implementations of the second aspect, the wireless connections of the plurality of one-to-one links include BLUETOOTH. In this embodiment of the present disclosure, BLUETOOTH may be used to implement the wireless connections of the plurality of one-to-one links between the input device and the plurality of host devices.

With reference to the second aspect, in some implementations of the second aspect, before the receiving first receiving data sent by the input device, the method further includes: receiving an air interface slot allocated by the input device, where the air interface slot is different from an air interface slot allocated to the other host device by the input device. In this embodiment of the present disclosure, when there are wireless connections of a plurality of one-to-one links between the input device and the plurality of host devices, the input device may serve as a master node to allocate air interface slots to the plurality of host devices.

With reference to the second aspect, in some implementations of the second aspect, when the host device is a host device that is the first to establish a connection to the input device, before the receiving first receiving data sent by the input device, the method further includes allocating an air interface slot to the host device, and allocating an air interface slot to the at least one other host device based on the air interface slot. In this embodiment of the present disclosure, when there are wireless connections of a plurality of one-to-one links between the input device and the plurality of host devices, the host device that is the first to establish a connection to the input device may serve as a master node to allocate an air interface slot to each host device.

With reference to the second aspect, in some implementations of the second aspect, the air interface slot allocated to the at least one other host device is different from each other, and is different from the air interface slot for the host device. In this embodiment of the present disclosure, an air interface slot for a one-to-one link between each host device and the input device is different from each other, thereby avoiding a slot conflict of the plurality of one-to-one links.

With reference to the second aspect, in some implementations of the second aspect, after the next focus host device receives the switching instruction, the next focus host device sends an activation message to the input device. The activation message is used to enable the input device to switch a link between the input device and the next focus host device from the keepalive state to the active state, and switch the link between the input device and the focus host device from the active state to the keepalive state. In this embodiment of the present disclosure, when there are wireless connections of a plurality of one-to-one links between the input device and the plurality of host devices, a next focus host sends a packet to the input device to activate a link.

With reference to the second aspect, in some implementations of the second aspect, there is a wireless connection of a one-to-many link between the input device and the host device and the at least one other host device. In this embodiment of the present disclosure, the input device may keep connected to the plurality of host devices at the same time through the wireless connection of the one-to-many link. There is no delay caused by time-division switching of a link on the one-to-many link, and there is no slot conflict between the plurality of one-to-one links. In this case, a data transmission delay is lower than a delay in the case of the plurality of one-to-one links, and scalability in a multi-screen case is better than scalability in the case of the plurality of one-to-one links.

With reference to the second aspect, in some implementations of the second aspect, the wireless connection of the one-to-many link includes BLUETOOTH or SPARKLINK. In this embodiment of the present disclosure, BLUETOOTH or SPARKLINK may be used to implement the wireless connection of the one-to-many link between the input device and the plurality of host devices.

With reference to the second aspect, in some implementations of the second aspect, the first receiving data is first input device data, and the second receiving data is second input device data. In this embodiment of the present disclosure, there is a wireless connection of a one-to-many link between the input device and the plurality of host devices. The input device sends the first sending data to the plurality of host devices at the same time, where the first sending data is the first input device data, and the plurality of host devices receive the first input device data at the same time. When the target image moves between screens of the plurality of host devices, a screen of the focus host device displays the target image, while the non-focus host device skips displaying the target image. After switching to the next focus host device to display the target image, the input device sends the second sending data to the plurality of host devices at the same time, where the second sending data is the first input device data. The plurality of host devices receives the second input device data at the same time. A screen of the next focus host device displays the target image, while the non-next focus host device skips displaying the target image.

With reference to the second aspect, in some implementations of the second aspect, when a quantity of other host devices is greater than or equal to 2, the at least one other host device is wirelessly connected to each other.

With reference to the second aspect, in some implementations of the second aspect, the input device includes a mouse, a touchpad, a trackball, or an eye recognition apparatus.

According to a third aspect, an embodiment of the present disclosure provides a data display system. The system includes the input device in the method according to any one of the first aspect and the plurality of host devices in the method according to any one of the second aspect.

According to a fourth aspect, an embodiment of the present disclosure provides an electronic device, including a processor and a memory. The memory is configured to store a computer program, the computer program includes program instructions, and when the processor runs the program instructions, the electronic device is enabled to perform steps of the foregoing methods.

According to a fifth aspect, an embodiment of the present disclosure provides a computer-readable storage medium. The computer-readable storage medium stores a computer program, the computer program includes program instructions, and when the program requests are run by a computer, the computer is enabled to perform the foregoing methods.

According to a sixth aspect, an embodiment of the present disclosure provides a computer program product. The computer program product includes instructions, and when the computer program product is run on a computer or any at least one processor, the computer is enabled to perform functions/steps in the foregoing methods.

In the technical solutions of a data display method and system, and an electronic device provided in embodiments of the present disclosure, a host device obtains a screen position relationship between the host device and at least one other host device; and an input device sends first sending data to a plurality of host devices, where the first sending data includes first input device data, the first input device data is used to enable a focus host device to display a target image, the target image moves along with movement of the input device, and the focus host device is a host device among the plurality of host devices that currently displays the target image. The host device receives first receiving data sent by the input device; and determines, based on the first receiving data and the screen position relationship, whether the host device is the focus host device, and skips displaying the target image when determining that the host device is a non-focus host device, or displays the target image when determining that the host device is the focus host device. The host device sends a switching instruction to a next focus host device based on the screen position relationship when the target image moves across a first screen edge of the host device, and the first screen edge is close to the next focus host device. The switching instruction is used to switch to the next focus host device to display the target image, and the next focus host device is a host device that is among the at least one other host device and that is close to the first screen edge of the host device. The input device sends second sending data to the plurality of host devices, where the second sending data includes second input device data, and the second input device data is used to enable the next focus host device to display the target image. The host device receives second receiving data sent by the input device, and skips displaying the target image. The input device keeps connected to the plurality of host devices at the same time, and link disconnection and establishment are not required, thereby reducing a switching delay.

### BRIEF DESCRIPTION OF DRAWINGS

FIG. 1 is a diagram of a structure of an electronic device according to an embodiment of the present disclosure;

FIG. 2 is a block diagram of a software structure of an electronic device 100 according to an embodiment of the present disclosure;

FIG. 3 is a diagram showing current switching of an input device between a plurality of host devices;

FIG. 4 is a diagram of a current data display solution;

FIG. 5 is a diagram of another current data display solution;

FIG. 6 is a diagram of an architecture of a data display system according to an embodiment of the present disclosure;

FIG. 7 is a diagram in which a network link between an input device and a plurality of host devices is a plurality of one-to-one links;

FIG. 8 is a diagram in which a network link between an input device and a plurality of host devices is a one-to-many link;

FIG. 9 is a flowchart of a data display method according to an embodiment of the present disclosure;

FIG. 10 is a flowchart of another data display method according to an embodiment of the present disclosure;

FIG. 11 is a diagram of a structure of an input device according to an embodiment of the present disclosure; and

FIG. 12 is a diagram of a structure of an input device according to an embodiment of the present disclosure.

### DESCRIPTION OF EMBODIMENTS

To make the technical solutions in the present disclosure more comprehensible, the following describes embodiments of the present disclosure in detail with reference to the accompanying drawings.

It should be clear that the described embodiments are merely some but not all of embodiments of the present disclosure. All other embodiments obtained by a person of ordinary skill in the art based on embodiments of the present disclosure without creative efforts shall fall within the protection scope of the present disclosure.

The terms used in embodiments of the present disclosure are merely for the purpose of illustrating specific embodiments, and are not intended to limit the present disclosure. The terms “a”, “the” and “this” of singular forms used in embodiments and the appended claims of the present disclosure are also intended to include plural forms, unless otherwise specified in the context clearly.

It should be understood that the term “and/or” used in this specification describes only an association relationship between associated objects and represents that three relationships may exist. For example, A and/or B may represent the following three cases: Only A exists, both A and B exist, and only B exists. In addition, the character “/” in this specification usually indicates an “or” relationship between the associated objects.

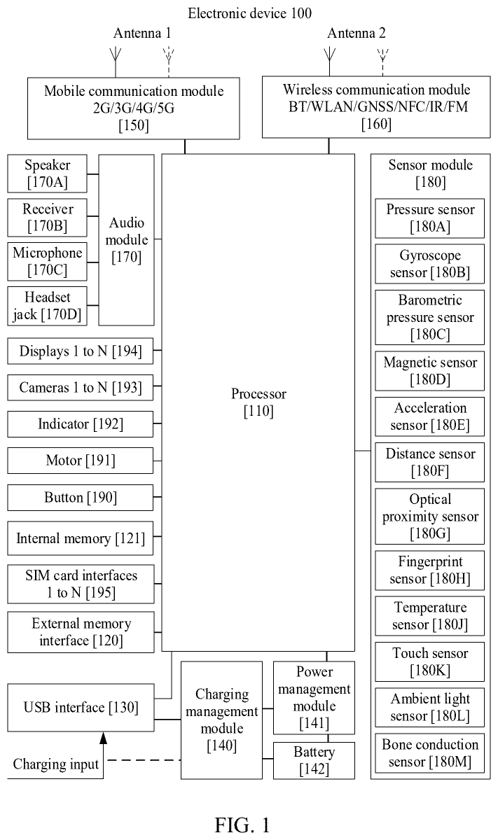

FIG. 1 is a diagram of a structure of an electronic device 100.

The electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of the present disclosure does not constitute a specific limitation on the electronic device 100. In some other embodiments of this disclosure, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent components, or may be integrated into one or more processors.

The controller may generate an operation control signal based on instruction operation code and a time sequence signal, to complete control of instruction fetching and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor may directly invoke the instructions or the data from the memory. This avoids repeated access and reduces waiting time of the processor 110, thereby improving efficiency of a system.

In some embodiments, the processor 110 may include one or more interfaces. The interface may include an inter-integrated circuit (I2C) interface, an inter-integrated circuit sound (I2S) interface, a pulse-code modulation (PCM) interface, a universal asynchronous receiver/transmitter (UART) interface, a mobile industry processor interface (MIPI), a general-purpose input/output (GPIO) interface, a SIM interface, a USB interface, and/or the like.

The I2C interface is a bidirectional synchronous serial bus, including a serial data line (SDA) and a serial clock line (SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the electronic device 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a BLUETOOTH headset.

The PCM interface may also be used to perform audio communication, and sample, quantize, and code an analog signal. In some embodiments, the audio module 170 may be coupled to the wireless communication module 160 through a PCM bus interface. In some embodiments, the audio module 170 may also transmit an audio signal to the wireless communication module 160 through the PCM interface, to implement a function of answering a call through a BLUETOOTH headset. Both the I2S interface and the PCM interface may be used for audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 110 to the wireless communication module 160. For example, the processor 110 communicates with a BLUETOOTH module in the wireless communication module 160 through the UART interface, to implement a BLUETOOTH function. In some embodiments, the audio module 170 may transmit an audio signal to the wireless communication module 160 through the UART interface, to implement a function of playing music through a BLUETOOTH headset.

The MIPI interface may be configured to connect the processor 110 to a peripheral component such as the display 194 or the camera 193. The MIPI interface includes a camera serial interface (CSI), a display serial interface (DSI), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, and the like. The GPIO interface may alternatively be configured as an I2C interface, an I2S interface, a UART interface, an MIPI interface, and the like.

The USB interface 130 is an interface that conforms to a USB standard specification, and may be specifically a mini USB interface, a micro USB interface, a USB type-C interface, or the like. The USB interface 130 may be configured to connect to a charger to charge the electronic device 100, or may be configured to transmit data between the electronic device 100 and a peripheral device, or may be configured to connect to a headset for playing audio through the headset. The interface may be further configured to connect to another electronic device such as an AR device.

It may be understood that an interface connection relationship between the modules shown in this embodiment of the present disclosure is merely an example for description, and does not constitute a limitation on a structure of the electronic device 100. In some other embodiments of this disclosure, the electronic device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some embodiments of wired charging, the charging management module 140 may receive a charging input from the wired charger through the USB interface 130. In some embodiments of wireless charging, the charging management module 140 may receive a wireless charging input through a wireless charging coil of the electronic device 100. The charging management module 140 supplies power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a battery state of health (leakage of electricity and impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that is applied to the electronic device 100 and that includes 2G/3G/4G/5G or the like. The mobile communication module 150 may include at least one filter, a switch, a power amplifier, a low-noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules of the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by an audio device (which is not limited to the speaker 170A, the receiver 170B, or the like), or displays an image or a video by the display 194. In some embodiments, the modem processor may be an independent component. In some other embodiments, the modem processor may be independent of the processor 110, and is disposed in a same device as the mobile communication module 150 or another functional module.

The wireless communication module 160 may provide a wireless communication solution that is applied to the electronic device 100 and that includes a wireless local area network (WLAN) (for example, a WI-FI network), BLUETOOTH (BT), a global navigation satellite system (GNSS), frequency modulation (FM), a near-field communication (NFC) technology, an infrared (IR) technology, or the like. The wireless communication module 160 may be one or more components integrating at least one communication processor module. The wireless communication module 160 receives an electromagnetic wave by the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, the antenna 1 and the mobile communication module 150 in the electronic device 100 are coupled, and the antenna 2 and the wireless communication module 160 in the electronic device 100 are coupled, so that the electronic device 100 can communicate with a network and another device by using a wireless communication technology. The wireless communication technology may include a Global System for Mobile Communications (GSM), a general packet radio service (GPRS), code-division multiple access (CDMA), wideband CDMA (WCDMA), time-division CDMA (TD-SCDMA), Long-Term Evolution (LTE), BT, a GNSS, a WLAN, NFC, FM, an IR technology, and/or the like. The GNSS may include a Global Positioning System (GPS), a global navigation satellite system (GLONASS), a BEIDOU navigation satellite system (BDS), a quasi-zenith satellite system (QZSS), and/or a satellite-based augmentation system (SBAS).

The electronic device 100 may implement a display function through the GPU, the display 194, the application processor, and the like. The GPU is a microprocessor for image processing, and is connected to the display 194 and the application processor. The GPU is configured to perform mathematical and geometric computation for graphic rendering. The processor 110 may include one or more GPUs, which execute program instructions to generate or change display information.

The display 194 is configured to display an image, a video, and the like. The display 194 includes a display panel. The display panel may be a liquid-crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light emitting diode (QLED), or the like. In some embodiments, the electronic device 100 may include one or N displays 194, where Nis a positive integer greater than 1.

The electronic device 100 may implement a photographing function by using the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scene. In some embodiments, the ISP may be disposed in the camera 193.

The camera 193 is configured to capture a static image or a video. An optical image of an object is generated through the lens, and is projected onto the photosensitive element. The photosensitive element may be a charge-coupled device (CCD) or a complementary metal-oxide-semiconductor (CMOS) phototransistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transform or the like on frequency energy.

The video codec is configured to compress or decompress a digital video. The electronic device 100 may support one or more video codecs. In this way, the electronic device 100 may play or record videos in a plurality of coding formats, for example, Moving Picture Experts Group (MPEG)-1, MPEG-2, MPEG-3, and MPEG-4.

The NPU is a neural-network (NN) computing processor. The NPU quickly processes input information with reference to a structure of a biological neural network, for example, a transfer mode between human brain neurons, and may further continuously perform self-learning. Applications such as intelligent cognition of the electronic device 100 may be implemented through the NPU, for example, image recognition, facial recognition, speech recognition, and text understanding.

The external memory interface 120 may be used to connect to an external storage card, for example, a micro (SECURE DIGITAL) SD card, to extend a storage capability of the electronic device 100. The external storage card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) and the like that are created during use of the electronic device 100. In addition, the internal memory 121 may include a high-speed random-access memory (RAM), and may further include a non-volatile memory, for example, at least one magnetic disk storage device, a flash memory, or universal flash storage (UFS). The processor 110 runs instructions stored in the internal memory 121 and/or instructions stored in the memory disposed in the processor, to perform various function applications and data processing of the electronic device 100.

The electronic device 100 may implement an audio function, for example, music playing or recording, through the audio module 170, the speaker 170A, the receiver 170B, the microphone 170C, the headset jack 170D, the application processor, and the like.

The audio module 170 is configured to convert digital audio information into an analog audio signal output, and is also configured to convert an analog audio input into a digital audio signal. The audio module 170 may be further configured to code and decode an audio signal. In some embodiments, the audio module 170 may be disposed in the processor 110, or some functional modules in the audio module 170 are disposed in the processor 110.

The speaker 170A, also referred to as a “loudspeaker”, is configured to convert an audio electrical signal into a sound signal. The electronic device 100 may be used to listen to music or answer a call in a hands-free mode over the speaker 170A.

The receiver 170B, also referred to as an “earpiece”, is configured to convert an audio electrical signal into a sound signal. When a call is answered or a voice message is received on the electronic device 100, the receiver 170B may be put close to a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. At least one microphone 170C may be disposed in the electronic device 100. In some other embodiments, two microphones 170C may be disposed in the electronic device 100, to implement a noise reduction function, in addition to collecting a sound signal. In some other embodiments, three, four, or more microphones 170C may alternatively be disposed in the electronic device 100, to collect a sound signal, implement noise reduction, and identify a sound source, to implement a directional recording function and the like.

The headset jack 170D is configured to connect to a wired headset. The headset jack 170D may be a USB interface 130, or may be a 3.5 millimeters (mm) Open Mobile Terminal Platform (OMTP) standard interface or CTIA standard interface.

The pressure sensor 180A is configured to sense a pressure signal, and can convert the pressure signal into an electrical signal. In some embodiments, the pressure sensor 180A may be disposed on the display 194. There is a plurality of types of pressure sensors 180A, such as a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The electronic device 100 determines a pressure strength based on the change in the capacitance. When a touch operation is performed on the display 194, the electronic device 100 detects a strength of the touch operation by using the pressure sensor 180A. The electronic device 100 may also calculate a touch position based on a detection signal of the pressure sensor 180A. In some embodiments, touch operations that are performed in a same touch position but have different touch operation strengths may correspond to different operation instructions. For example, when a touch operation with a touch operation strength less than a first pressure threshold is performed on an SMS message application icon, an instruction for viewing an SMS message is executed. When a touch operation with a touch operation strength greater than or equal to the first pressure threshold is performed on the Messages icon, an instruction for creating a new SMS message is executed.

The gyroscope sensor 180B may be configured to determine a motion gesture of the electronic device 100. In some embodiments, angular velocities of the electronic device 100 around three axes (namely, x, y, and z axes) may be determined by using the gyroscope sensor 180B. The gyroscope sensor 180B may be configured to implement image stabilization during photographing. For example, when a shutter is pressed, the gyroscope sensor 180B detects an angle at which the electronic device 100 jitters; calculates, based on the angle, a distance for which a lens module needs to compensate; and enables the lens to cancel the jitter of the electronic device 100 through reverse motion, to implement image stabilization. The gyroscope sensor 180B may be further used in a navigation scenario and a somatic game scenario.

The barometric pressure sensor 180C is configured to measure barometric pressure. In some embodiments, the electronic device 100 calculates an altitude by using a barometric pressure value measured by the barometric pressure sensor 180C, to assist in positioning and navigation.

The magnetic sensor 180D includes a Hall sensor. The electronic device 100 may detect opening and closing of a flip leather case by using the magnetic sensor 180D. In some embodiments, when the electronic device 100 is a flip phone, the electronic device 100 may detect opening and closing of a flip cover by using the magnetic sensor 180D. Further, a feature such as automatic unlocking of the flip cover is set based on a detected open/closed state of the leather case or a detected open/closed state of the flip cover.

The acceleration sensor 180E may detect accelerations in various directions (usually on three axes) of the electronic device 100. When the electronic device 100 is still, a magnitude and a direction of gravity may be detected. The acceleration sensor 180E may be further configured to identify a posture of the electronic device, and is used in an application such as switching between a landscape mode and a portrait mode or a pedometer.

The distance sensor 180F is configured to measure a distance. The electronic device 100 may measure a distance through infrared or laser. In some embodiments, in a photographing scene, the electronic device 100 may measure a distance by using the distance sensor 180F, to implement quick focusing.

The optical proximity sensor 180G may include, for example, a light-emitting diode (LED) and an optical detector, for example, a photodiode. The light emitting diode may be an infrared light-emitting diode. The electronic device 100 emits infrared light to the outside by using a light emitting diode. The electronic device 100 detects infrared reflected light from a nearby object through the photodiode. When sufficient reflected light is detected, it may be determined that there is an object near the electronic device 100. When insufficient reflected light is detected, the electronic device 100 may determine that there is no object near the electronic device 100. The electronic device 100 may detect, by using the optical proximity sensor 180G, that the user holds the electronic device 100 close to an ear for a call, to automatically perform screen-off for power saving. The optical proximity sensor 180G may also be used in a leather cover mode or a pocket mode to automatically perform screen unlocking or locking.

The ambient light sensor 180L is configured to sense ambient light brightness. The electronic device 100 may adaptively adjust brightness of the display 194 based on the sensed ambient light brightness. The ambient light sensor 180L may also be configured to automatically adjust white balance during photographing. The ambient light sensor 180L may further cooperate with the optical proximity sensor 180G to detect whether the electronic device 100 is in a pocket, to avoid an accidental touch.

The fingerprint sensor 180H is configured to collect a fingerprint. The electronic device 100 may use a feature of the collected fingerprint to implement fingerprint-based unlocking, application lock access, fingerprint-based photographing, fingerprint-based call answering, and the like.

The temperature sensor 180J is configured to detect a temperature. In some embodiments, the electronic device 100 executes a temperature processing policy through the temperature detected by the temperature sensor 180J. For example, when the temperature reported by the temperature sensor 180J exceeds a threshold, the electronic device 100 lowers performance of a processor located near the temperature sensor 180J, to reduce power consumption for thermal protection. In some other embodiments, when the temperature is lower than another threshold, the electronic device 100 heats the battery 142 to avoid abnormal shutdown of the electronic device 100 caused by a low temperature. In some other embodiments, when the temperature is lower than still another threshold, the electronic device 100 boosts an output voltage of the battery 142 to avoid abnormal shutdown caused by a low temperature.

The touch sensor 180K is also referred to as a “touch component”. The touch sensor 180K may be disposed on the display 194, and the touch sensor 180K and the display 194 constitute a touchscreen, which is also referred to as a “touch screen”. The touch sensor 180K is configured to detect a touch operation performed on or near the touch sensor. The touch sensor may transfer the detected touch operation to the application processor to determine a type of a touch event. A visual output related to the touch operation may be provided through the display 194. In some other embodiments, the touch sensor 180K may also be disposed on a surface of the electronic device 100 at a position different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a pulse of a human body, to receive a blood pressure beat signal. In some embodiments, the bone conduction sensor 180M may also be disposed in a headset to be combined into a bone conduction headset. The audio module 170 may obtain a speech signal through parsing based on the vibration signal that is of the vibration bone of the vocal-cord part and that is obtained by the bone conduction sensor 180M, to implement a speech function. The application processor may parse out heart rate information based on the blood pressure beat signal obtained by the bone conduction sensor 180M, to implement a heart rate detection function.

The button 190 includes a power button, a volume button, and the like. The button 190 may be a mechanical button, or may be a touch button. The electronic device 100 may receive a button input, and generate a button signal input related to user setting and function control of the electronic device 100.

The motor 191 may generate a vibration prompt. The motor 191 may be configured to provide an incoming call vibration prompt and touch vibration feedback. For example, touch operations performed on different applications (for example, photographing and audio playback) may correspond to different vibration feedback effect. The motor 191 may also correspond to different vibration feedback effect for touch operations performed on different areas of the display 194. Different application scenarios (for example, a time reminder, information receiving, an alarm clock, and a game) may also correspond to different vibration feedback effect. Touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface 195 is also compatible with an external storage card. The electronic device 100 interacts with a network through the SIM card, to implement functions such as calling and data communication. In some embodiments, the electronic device 100 uses an eSIM, that is, an embedded SIM card. The eSIM card may be embedded into the electronic device 100, and cannot be separated from the electronic device 100.

A software system of the electronic device 100 may use a layered architecture, an event-driven architecture, a microkernel architecture, a micro service architecture, or a cloud architecture. In this embodiment of the present disclosure, an Android system of a layered architecture is used as an example for describing a software structure of the electronic device 100.

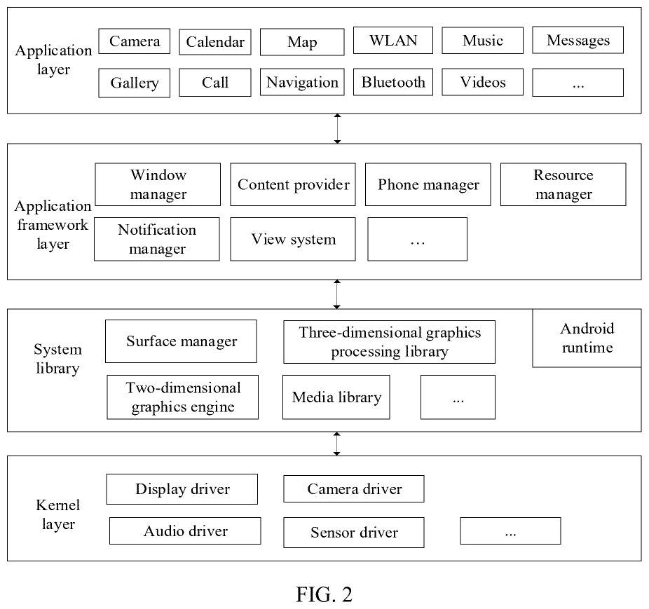

FIG. 2 is a block diagram of a software structure of the electronic device 100 according to an embodiment of the present disclosure.

In a layered architecture, software is divided into several layers, and each layer has a clear role and task. The layers communicate with each other through a software interface. In some embodiments, the Android system is divided into four layers: an application layer, an application framework layer, an Android runtime and system library layer, and a kernel layer from top to bottom.

The application layer may include a series of application packages.

As shown in FIG. 2, the application packages may include applications such as camera, gallery, calendar, call, map, navigation, WLAN, BLUETOOTH, music, videos, and messages.

The application framework layer provides an application programming interface (API) and a programming framework for an application at the application layer. The application framework layer includes some predefined functions.

As shown in FIG. 2, the application framework layer may include a window manager, a content provider, a view system, a phone manager, a resource manager, a notification manager, and the like.

The window manager is configured to manage a window program. The window manager may obtain a size of the display, determine whether there is a status bar, perform screen locking, take a screenshot, and the like.

The content provider is used to store and obtain data, and enables these data to be accessible to an application. The data may include a video, an image, an audio, calls that are made and answered, a browsing history and bookmarks, an address book, and the like.

The view system includes visual controls such as a control for displaying a text and a control for displaying an image. The view system may be used to construct an application. A display interface may include one or more views. For example, a display interface including an SMS message notification icon may include a text display view and an image display view.

The phone manager is configured to provide a communication function for the electronic device 100, for example, management of a call status (including answering, declining, or the like).

The resource manager provides an application with various resources, such as a localized character string, an icon, a picture, a layout file, and a video file.

The notification manager enables an application to display notification information in a status bar, and may be used to convey a notification-type message. The displayed notification information may automatically disappear after a short pause without user interaction. For example, the notification manager is used to notify download completion, provide a message notification, and the like. The notification manager may alternatively be a notification that appears in a top status bar of the system in a form of a graph or a scroll bar text, for example, a notification of an application that is run on a background, or may be a notification that appears on the screen in a form of a dialog window. For example, text information is displayed in the status bar, an alert tone is made, the electronic device vibrates, or the indicator light blinks.

The Android runtime includes a kernel library and a virtual machine. The Android runtime is responsible for scheduling and management of the Android system.

The kernel library includes two parts: a performance function that needs to be called in a Java language and a kernel library of Android.

The application layer and the application framework layer run on the virtual machine. The virtual machine executes Java files at the application layer and the application framework layer as binary files. The virtual machine is used to perform functions such as object lifecycle management, stack management, thread management, security and exception management, and garbage collection.

The system library may include a plurality of functional modules, for example, a surface manager, a media library, a three-dimensional graphics processing library (for example, an OpenGL ES), and a two-dimensional (2D) graphics engine (for example, an SGL).

The surface manager is configured to manage a display subsystem and provide fusion of 2D and three-dimensional (3D) layers for a plurality of applications.

The media library supports playback and recording in a plurality of commonly used audio and video formats, and static image files. The media library may support a plurality of audio and video encoding formats, for example, MPEG-4, H.264, MP3, AAC, AMR, JPG, and PNG.

The three-dimensional graphics processing library is used to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

The following describes an example of a working process of software and hardware of the electronic device 100 with reference to a photo capturing scenario.

When the touch sensor 180K receives a touch operation, a corresponding hardware interrupt is sent to the kernel layer. The kernel layer processes the touch operation into an original input event (including information such as touch coordinates and a time stamp of the touch operation). The original input event is stored at the kernel layer. The application framework layer obtains the original input event from the kernel layer, and identifies a control corresponding to the input event. An example in which the touch operation is a touch operation and a control corresponding to the touch operation is a control of a camera application icon is used. A camera application invokes an interface of the application framework layer to start the camera application, then starts the camera driver by invoking the kernel layer, and captures a static image or a video by using the camera 193.

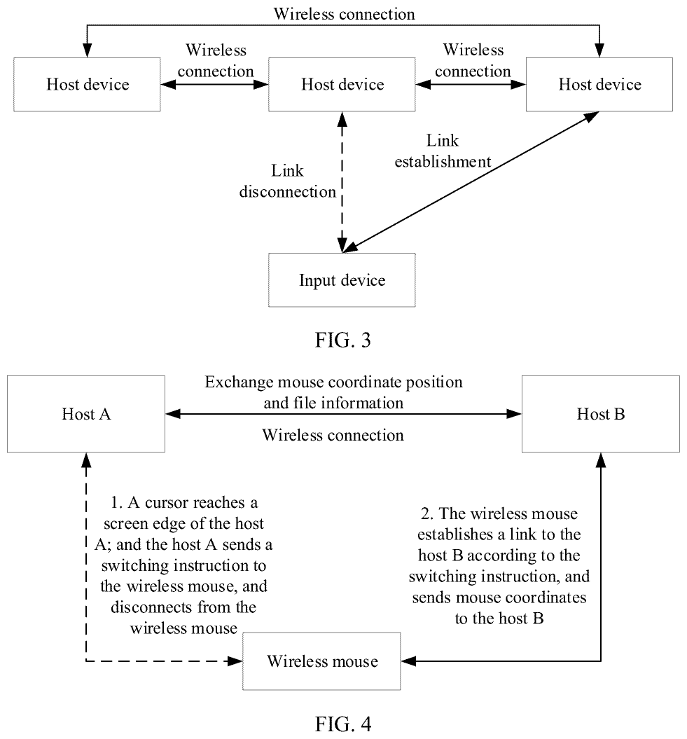

FIG. 3 is a diagram showing current switching of an input device between a plurality of host devices. As shown in FIG. 3, the host devices communicate with each other through wireless connections, and the input device is usually connected to the host device through BLUETOOTH. The host device usually serves as a master node, and the input device usually serves as a slave node. The input device establishes a BLUETOOTH connection to a focus host device in the plurality of host devices. The input device transmits data to the focus host device. The focus host device is a host device among the plurality of host devices that currently displays an image corresponding to the data. In a process of switching to another host device as a next focus host device to display the image corresponding to the data, the input device disconnects from the focus host device and establishes a connection to the next focus host device. This process has a long delay, usually reaching tens of to hundreds of milliseconds, and does not support fast switching.

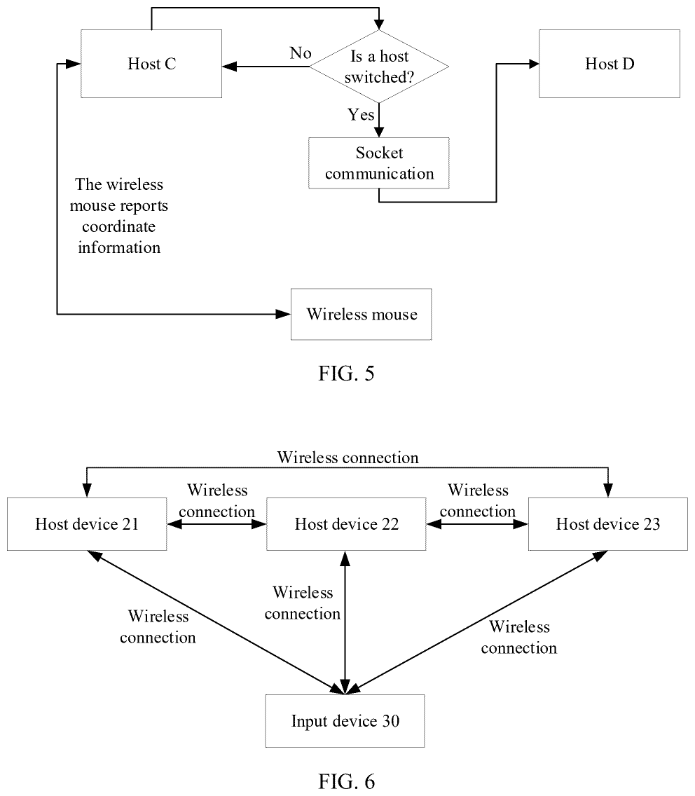

For example, the input device is a wireless mouse. FIG. 4 is a diagram of a current data display solution, and FIG. 5 is a diagram of another current data display solution. In a moving process, the wireless mouse transmits a relative coordinate value to the host device, and the relative coordinate value represents planar displacement between a previous transmission and a current transmission.

As shown in FIG. 4, the wireless mouse maintains a BLUETOOTH connection to only one host device, that is, a host A. The host A communicates with a host B through a wireless connection to exchange a coordinate position of the wireless mouse and file information. When the host A detects that a cursor reaches a screen edge, the host A sends a switching instruction to the wireless mouse, and disconnects from the wireless mouse. The wireless mouse establishes a link to the host B according to the switching instruction. Specifically, the wireless mouse sends a directed broadcast to the host B, and then the host B reconnects to the wireless mouse. After the wireless mouse re-establishes a BLUETOOTH link to the host B, the wireless mouse sends mouse coordinates to the host B. Relative positions of the host A and the host B in terms of up, down, left, and right are set by a user when a multi-screen traversal function is configured at the beginning. In FIG. 4, the wireless mouse maintains a connection to only one host device. If the wireless mouse is connected to another host, a BLUETOOTH link needs to be re-established, and a delay is large in the case of a plurality of host devices. A larger quantity of screens indicates a larger quantity of times of link disconnection and link establishment, leading to poor scalability. Therefore, in this data display solution, each time an input device is switched between a plurality of host devices, a BLUETOOTH link needs to be re-established, resulting in a large delay and poor scalability.

As shown in FIG. 5, the wireless mouse maintains a BLUETOOTH connection to only one host device, that is, a host C. The host C communicates with another host device, that is, a host D, through a wireless connection. The host C performs virtualization processing on a control instruction of the wireless mouse, and then through interaction between hosts, directly transfers a processed instruction to the host D and controls the host D to display a cursor and an operation instruction. Relative positions of the host C and the host D in terms of up, down, left, and right are set by a user when a multi-screen traversal function is configured at the beginning. In FIG. 5, the wireless mouse maintains a connection to only one host device, that is, the host C, and the wireless mouse reports coordinate information to the host C. The host C determines, based on the coordinate information and a screen position relationship between the host C and the host D, whether a host is switched. If determining that the host is not switched, the host C displays and moves a cursor based on the coordinate information. If determining that the host is switched, the host C forwards the coordinate information to the host D through socket communication. The host D displays and moves the cursor based on the coordinate information. Therefore, the wireless mouse in FIG. 5 maintains a connection to only one host device. After the cursor moves to another host device, mouse coordinate data needs to be forwarded by using the host C each time, which causes an extra forwarding delay, resulting in a large delay. In this data display solution, after the cursor moves to another host device, the mouse coordinate data needs to be forwarded by using the host C each time, which causes an extra forwarding delay.

In conclusion, in a scenario in which an input device is switched between a plurality of host devices, in a current data display solution, the input device maintains a single BLUETOOTH physical connection to only one host device. When the input device is switched between the plurality of host devices, a link needs to be re-established or input device data needs to be forwarded, resulting in a large delay. In addition, if the input device serves as a slave node (slave) and establishes a BLUETOOTH connection to a plurality of host devices at the beginning, slot conflicts are likely to occur among the plurality of host devices serving as a plurality of master nodes (master), affecting experience.

Based on the foregoing technical problem, an embodiment of the present disclosure provides a data display system. FIG. 6 is a diagram of an architecture of a data display system according to an embodiment of the present disclosure. The data display system provided in this embodiment of the present disclosure is applied to a scenario in which host devices are connected to one input device. Content displayed on a screen of each host device is information in the host device, and content displayed on screens of different host devices is different. The input device can traverse across a plurality of screens and supports file dragging between different screens. The input device includes a mouse, a touchpad, a trackball, an eye recognition apparatus, or the like. The host device includes a terminal device having a display capability, for example, a mobile phone, a tablet, a notebook computer, or an integrated machine. For a hardware structure and a software structure of the host device provided in embodiments of the present disclosure, refer to related descriptions of the electronic device 100 in FIG. 1 and FIG. 2.

As shown in FIG. 6, the data display system includes an input device 30 and a plurality of host devices 20. The plurality of host devices 20 include at least two host devices, and the host device includes a screen. The plurality of host devices 20 are wirelessly connected. In an initial connection configuration process, the plurality of host devices 20 prompt a user to select and determine a screen position relationship between the plurality of host devices 20 through a related application (for example, AI Life). Each host device needs to obtain the screen position relationship between the plurality of host devices 20. Each host device is wirelessly connected to the input device 30. In this embodiment of the present disclosure, a network link can be established in advance between the input device 30 and the plurality of host devices 20. When the input device 30 moves between the plurality of host devices 20, a link does not need to be re-established between the host device and the input device 30, and input device data does not need to be forwarded, so that a data transmission delay of the input device 30 can be reduced, and scalability in a multi-screen case can be improved.

For example, the plurality of host devices 20 include three host devices: a first host device 21, a second host device 22, and a third host device 23. As shown in FIG. 6, the first host device 21, the second host device 22, and the third host device 23 are wirelessly connected to each other, for example, connected through WI-FI. A screen position relationship between the first host device 21, the second host device 22, and the third host device 23 is that a screen of the first host device 21 is located on a left side of a screen of the second host device 22, and a screen of the third host device 23 is located on a right side of the screen of the second host device 22. The first host device 21, the second host device 22, and the third host device 23 are all wirelessly connected to the input device 30, for example, connected through BLUETOOTH.

The input device 30 sends first sending data to the plurality of host devices 20. The first sending data includes first input device data, the first input device data is used to enable a focus host device to display a target image, the target image moves along with movement of the input device 30, and the focus host device is a host device among the plurality of host devices 20 that currently displays the target image. Data sent by the input device 30 and received by each host device is the same or different.

The host device receives first receiving data sent by the input device 30, and determines, based on the first receiving data and the screen position relationship, whether the host device is the focus host device. If determining that the host device is the focus host device, the host device displays the target image corresponding to the first receiving data; or if determining that the host device is a non-focus host device, the host device skips displaying the target image. It should be noted that the focus host device that currently displays the target image can only be one of the plurality of host devices 20. The host device sends a switching instruction to a next focus host device based on the screen position relationship when the target image moves across a first screen edge of the host device, that is, the focus host device, and the first screen edge is close to the next focus host device. The switching instruction is used to enable the next focus host device to display the target image, and the next focus host device is a host device among the plurality of host devices 20 that is close to the first screen edge of the focus host device.

Then, the input device 30 sends second sending data to the plurality of host devices 20. The second sending data includes second input device data, and the second input device data is used to enable the next focus host device to display the target image. The next focus host device is a non-focus host device among the plurality of host devices that is close to the first screen edge. Data sent by the input device 30 and received by each host device is the same or different.

Then, the host device receives second receiving data sent by the input device 30, determines, based on the second receiving data and the screen position relationship, that the host device is a non-next focus host device, and skips displaying the target image.

As shown in FIG. 6, it is assumed that the input device 30 is a wireless mouse, and the second host device 22 is a focus host device that currently displays a cursor. The wireless mouse sends first sending data to the plurality of host devices 20, where the first sending data includes first mouse position data. The second host device 22 determines, based on a screen position relationship and received data sent by the input device 30, that the second host device 22 is a focus host device, and displays the cursor corresponding to the first mouse position data. The first host device 21 and the third host device 23 determine, based on the screen position relationship and the received data sent by the input device 30, that the first host device 21 and the third host device 23 are non-focus host devices, and skip displaying the cursor. The user moves the input device 30 so that the cursor moves to a right edge of the screen of the second host device 22. The second host device 22 determines, based on a screen position relationship, that the next focus host device is the third host device 23, and sends a switching instruction to the third host device 23. Then, the wireless mouse sends second sending data to the plurality of host devices 20. The second sending data includes second mouse position data, and the third host device 23 displays the cursor corresponding to the second mouse position data.

In this embodiment of the present disclosure, a network link between the input device 30 and the plurality of host devices 20 includes a plurality of one-to-one links or a one-to-many link.

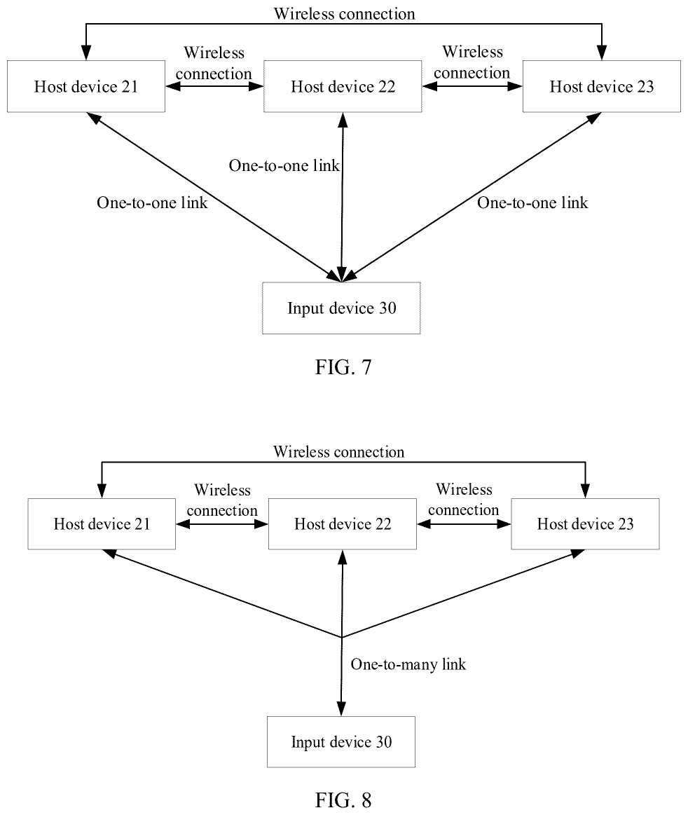

FIG. 7 is a diagram in which a network link between an input device and a plurality of host devices is a plurality of one-to-one links. For example, the plurality of host devices 20 include three host devices: a first host device 21, a second host device 22, and a third host device 23. As shown in FIG. 7, the input device 30 establishes a one-to-one link to each host device. For example, the one-to-one link is a BLUETOOTH link. When the input device 30 sends data to the plurality of host devices 20, all the host devices receive the data at the same time and reply with an acknowledgment character (ACK)/lost packet retransmission (NACK) to the input device 30. The first focus host device is usually a host device that is the first to establish a connection to the input device.

For example, a link between the input device 30 and the focus host device is in an active state, and a link between the input device 30 and a non-focus host device is in a keepalive state. Therefore, data sent by the input device 30 to the focus host device is different from data sent to the non-focus host device.

For example, the first sending data further includes null packet data. That the input device 30 sends first sending data to the plurality of host devices 20 further includes that the input device 30 sends the first input device data to the focus host device, and sends the null packet data to the non-focus host device. Therefore, it can be ensured that only the focus host device receives the first input device data and displays the target image, and the rest of the host devices receive only the null packet data to maintain a heartbeat connection to the input device 30, and skip displaying the target image. Therefore, when the host device is the focus host device, the first receiving data is the first input device data; or when the host device is the non-focus host device, the first receiving data is the null packet data. The host device can determine, based on the received data sent by the input device 30, whether the host device is the focus host device. Specifically, if the data is the null packet data, it is determined that the host device is the non-focus host device. Alternatively, if the data is the first input data, it is determined that the host device is the focus host device.

For example, the input device 30 sends second sending data to the plurality of host devices further includes that the input device 30 sends the second input device data to the next focus host device, and sends the null packet data to the rest of the host devices. Therefore, after the focus host device is switched, it is ensured that only the next focus host device can receive the second input device data and display the target image, and the rest of the host devices receive only the null packet data to maintain a heartbeat connection to the input device 30, and skip displaying the target image. Therefore, when the host device is the focus host device, the second receiving data is the null packet data; or when the host device is the next focus host device, the second receiving data is the second input device data. A network link between the input device 30 and the plurality of host devices 20 is a plurality of one-to-one links. When the input device 30 sends the first sending data to the plurality of host devices 20 for the first time, a host device that is the first to establish a connection to the input device 30 is considered as a first focus host device by default. When switching to a second focus host device subsequently, the first focus host device sends a switching instruction to the second focus host device, and the second focus host device sends an activation message to the input device 30 according to the switching instruction. The activation message is used to enable the input device 30 to switch a link between the input device 30 and the second focus host device from the keepalive state to the active state, and switch a link between the input device 30 and the first focus host device from the active state to the keepalive state. A connection between the host devices may be a single connection, or may be a plurality of connections. For example, in FIG. 7, the plurality of host devices includes three host devices, and the second host device 22 is connected to the first host device 21 and the third host device 23. If the plurality of host devices includes four host devices, that is, the first host device 21, the second host device 22, the third host device 23, and a fourth host device. The second host device 22 may be connected to the first host device 21 and the third host device 23, or the second host device 22 may be connected to the first host device 21, the third host device 23, and the fourth host device.

The input device 30 serves as a master, or a host device for each one-to-one link serves as a master.

Optionally, the input device 30 serves as a master. As shown in FIG. 7, it is assumed that the first host device 21 is a host device that is the first to establish a connection to the input device 30, the second host device 22 is a host device that is the second to establish a connection to the input device 30, and the third host device 23 is a host device that is the third to establish a connection to the input device 30. Before the input device 30 sends the first sending data to the plurality of host devices 20, the input device 30 allocates a first air interface slot to the first host device 21, and allocates air interface slots to the rest of the host devices based on the first air interface slot. Specifically, the input device 30 allocates a second air interface slot to the second host device 22 based on the first air interface slot, and allocates a third air interface slot to the third host device 23 based on the first air interface slot and the second air interface slot. The first air interface slot, the second air interface slot, and the third air interface slot are different, which can avoid a slot conflict that may exist between the plurality of one-to-one links. Therefore, the input device 30 sends data to the first host device 21 based on the first air interface slot, the input device 30 sends data to the second host device 22 based on the second air interface slot, and the input device 30 sends data to the third host device 23 based on the third air interface slot. Therefore, the input device 30 allocates the first air interface slot to the host device that is the first to establish a connection to the input device 30, and allocates the air interface slots to the rest of the host devices based on the first air interface slot.

Optionally, a host device for each one-to-one link serves as a master. The input device 30 first establishes a plurality of one-to-one links to the plurality of host devices 20. A one-to-one link between the input device 30 and the host device (that is, the first host device) that is the first to establish a connection to the input device 30 is based on an air interface slot allocated by the first host device, that is, a fourth air interface slot. A link parameter, that is, an initial air interface slot, of a one-to-one link between the input device 30 and another host device cannot be directly used; and if the link parameter is directly used, a slot conflict may occur. Therefore, the link parameter needs to be updated. Because a host device for each one-to-one link is used as a master, and the input device 30 is used as a slave device, another host device updates the link parameter by negotiating with the first host device, and the first host device implicitly serves as a master between the plurality of host devices 20. As shown in FIG. 7, it is assumed that the first host device 21 is a host device that is the first to establish a connection to the input device 30, the second host device 22 is a host device that is the second to establish a connection to the input device 30, and the third host device 23 is a host device that is the third to establish a connection to the input device 30. Before the input device 30 sends the first sending data to the plurality of host devices 20, the first host device 21 allocates a fourth air interface slot to a one-to-one link between the input device 30 and the first host device 21; and allocates an air interface slot, that is, an updated link parameter, to a one-to-one link between the input device 30 and the rest of the host devices based on the fourth air interface slot. In an optional solution, the first host device 21 sends, to the input device 30 based on the fourth air interface slot, a fifth air interface slot allocated to a one-to-one link between the input device 30 and the second host device 22, where the input device 30 is configured to forward the fifth air interface slot to the second host device 22; and sends, to the input device 30 based on the fourth air interface slot and the fifth air interface slot, a sixth air interface slot allocated to a one-to-one link between the input device 30 and the third host device 23, where the input device 30 is configured to forward the sixth air interface slot to the third host device 23. In another optional solution, the first host device 21 sends, to the second host device 22 based on the fourth air interface slot, a fifth air interface slot allocated to a one-to-one link between the input device 30 and the second host device 22; and sends, to the third host device 23 based on the fourth air interface slot and the fifth air interface slot, a sixth air interface slot allocated to a one-to-one link between the input device 30 and the third host device 23. The fourth air interface slot, the fifth air interface slot, and the sixth air interface slot are different, which can avoid a slot conflict that may exist between the plurality of one-to-one links. Therefore, the input device 30 sends data to the first host device 21 based on the fourth air interface slot, the input device 30 sends data to the second host device 22 based on the fifth air interface slot, and the input device 30 sends data to the third host device 23 based on the sixth air interface slot. Therefore, that the input device 30 sends first sending data to the plurality of host devices 20 includes that the input device 30 sends, based on the fourth air interface slot allocated by the host device that is the first to establish a connection to the input device 30, data to the host device that is the first to establish a connection to the input device 30, and sends data to the rest of the host devices based on air interface slots allocated to the rest of the host devices by the host device that is the first to establish a connection to the input device 30.

In conclusion, an air interface slot used by each of the plurality of host devices 20 to perform wireless transmission with the input device 30 is different from each other, so that a slot conflict that may exist between the plurality of one-to-one links can be avoided.

A network link between the input device 30 and the plurality of host devices 20 is a plurality of one-to-one links. After the next focus host device receives the switching instruction, the next focus host device sends the activation message to the input device. The activation message is used to enable the input device 30 to switch the link between the input device 30 and the next focus host device from the keepalive state to the active state, and switch the link between the input device 30 and the focus host device from the active state to the keepalive state.

In this embodiment of the present disclosure, a one-to-one link can be established in advance between the input device 30 and each of the plurality of host devices 20. When the input device 30 moves between the plurality of host devices 20, a link does not need to be re-established between the host device and the input device 30, and input device data does not need to be forwarded, so that a data transmission delay of the input device 30 can be reduced, and scalability in a multi-screen case can be improved. In addition, regardless of whether the input device 30 serves as a master or the host device that is the first to establish a connection to the input device 30 serves as a master, an air interface slot used for each one-to-one link is different from each other. In this way, a slot conflict that may exist between the plurality of one-to-one links can be avoided.

FIG. 8 is a diagram in which a network link between an input device and a plurality of host devices is a one-to-many link. For example, the plurality of host devices 20 include three host devices: a first host device 21, a second host device 22, and a third host device 23. As shown in FIG. 8, the input device 30 establishes a one-to-many link to the plurality of host devices 20. For example, the one-to-many link includes BLUETOOTH or SPARKLINK. The input device 30 serves as a master. After the input device 30 establishes a one-to-many link to the plurality of host devices 20, during initialization, the input device 30 selects, randomly or by default, one host device from the plurality of host devices 20 as a first focus host device.

When the input device 30 sends data to the plurality of host devices 20, all the host devices receive the data at the same time and reply with an ACK/NACK to the input device 30. Data sent by the host device 20 and received by all host devices is the same. The first sending data is first input device data, and the second sending data is second input device data. Therefore, that the input device 30 sends first sending data to the plurality of host devices 20 includes that the input device 30 sends the first input device data to both a focus host device and a non-focus host device. That the input device 30 sends second sending data to the plurality of host devices 20 includes that the input device 30 sends the second input device data to both the focus host device and the non-focus host device. Therefore, first receiving data received by the host device is the first input device data, and second receiving data is the second input device data.

Only the focus host device displays the target image. Although the non-focus host also receives the input device data, the non-focus host skips displaying the target image. As shown in FIG. 8, the second host device 22 is a focus host device that currently displays the target image. The input device 30 sends the first input device data to the plurality of host devices 20. The second host device 22 determines, based on a screen position relationship and the first input device data, that the second host device 22 is a focus host device, and displays the target image corresponding to the first input device data. The first host device 21 and the third host device 23 determine, based on the screen position relationship and the first input device data, that the first host device 21 and the third host device 23 are non-focus host devices, and skip displaying the target image. A user moves the input device 30 so that the target image moves to a right edge of a screen of the second host device 22. The second host device 22 determines, based on the screen position relationship and the first input device data, that the third host device 23 is a next focus host device, skips displaying the target image, and sends a switching instruction to the third host device 23. Then, the input device 30 sends second mouse position data to the plurality of host devices 20, the third host device 23 displays the target image, and neither the first host device 21 nor the second host device 22 displays the target image.

Each host device receives the same data sent by the input device 30, that is, the first input data. Therefore, coordinates of the displayed target image further need to be determined with reference to the screen position relationship, and whether the coordinates are located on a screen of the host device is determined. If the coordinates are located on the screen of the host device, it is determined that the host device is the focus host device. If the coordinates are not located on the screen of the host device, it is determined that the host device is the non-focus host device.

Optionally, the one-to-one link is BLUETOOTH, and a private multicast form with an ACK feedback needs to be used.

Optionally, the one-to-one link is SPARKLINK, and a corresponding frame format may be a radio frame type 1, a radio frame type 2, a radio frame type 3, or a radio frame type 4. Preferably, the radio frame type 2 serves as a low-delay frame, and is most likely to be applied to a keyboard and mouse scenario. A corresponding format for the radio frame type 2 is shown in Table 1.

TABLE 1
Frame format for the radio frame type 2

| | | | | | |
|---|---|---|---|---|---|
| Preamble | Synchro- | Physical | Physical | Integrity | Cyclic |
| signal | nization | layer | layer | protection | redundancy |
| | signal 2 | control | data | field | check |
| | | infor- | infor- | | field |
| | | mation | mation | | |

In this embodiment of the present disclosure, a one-to-many link can be established in advance between the input device 30 and the plurality of host devices 20. The input device 30 sends input device data to the plurality of host devices 20, and the plurality of host devices 20 receive the input device data at the same time, instead of receiving the input device data in a time-division manner. When the input device 30 moves between the plurality of host devices 20, the host device, to which the input device 30 moves, displays the target image corresponding to the input device data, and the rest of the host devices skip displaying the target image. The plurality of host devices 20 notify, through wireless communication (for example, a WI-FI link), a screen of the next focus host device to display the target image. There is no time-division switching process for a plurality of links, and there is no slot conflict between the plurality of one-to-one links. In this case, a data transmission delay for the input device is lower than a delay in the case of the plurality of one-to-one links, and scalability in a multi-screen case is better than scalability in the case of the plurality of one-to-one links.

In conclusion, according to the data display system provided in this embodiment of the present disclosure, the input device 30 is connected to the plurality of host devices. The input device keeps connected to the plurality of host devices at the same time, and a link does not need to be disconnected and then established. When connected to the focus host device, the input device may further maintain a heartbeat connection to at least one non-focus host device to exchange information, so that the input device 30 may exchange information with the plurality of host devices in real time in the background. The focus host device directly sends the switching instruction to a next focus host to which the input device 30 is to move. For a one-to-one link, the next focus host sends a packet to the input device 30 to activate the link. For a one-to-many link, the next focus host selectively displays the input device data, so that scalability is good in a multi-screen scenario, and a switching delay is low.

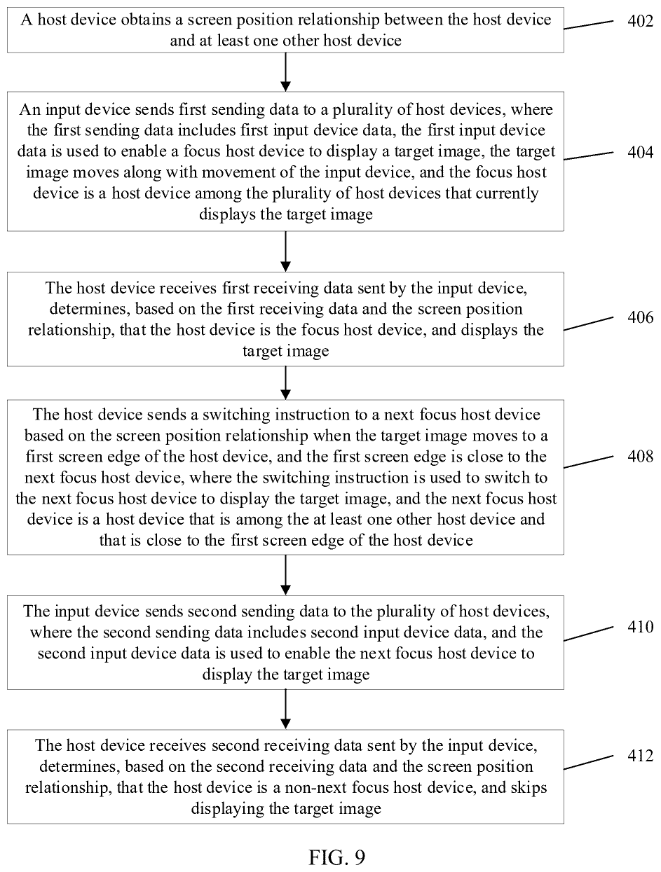

Based on the foregoing data display system, an embodiment of the present disclosure provides a data display method. FIG. 9 is a flowchart of a data display method according to an embodiment of the present disclosure. As shown in FIG. 9, the method includes the following steps.

Step 402: A host device obtains a screen position relationship between the host device and at least one other host device.

In this embodiment of the present disclosure, the host device is wirelessly connected to the at least one other host device, and both the host device and the at least one other host device are wirelessly connected to an input device.

Step 404: The input device sends first sending data to a plurality of host devices, where the first sending data includes first input device data, the first input device data is used to enable a focus host device to display a target image, the target image moves along with movement of the input device, and the focus host device is a host device among the plurality of host devices that currently displays the target image.

Step 406: The host device receives first receiving data sent by the input device, determines, based on the first receiving data and the screen position relationship, that the host device is the focus host device, and displays the target image.

Step 408: The host device sends a switching instruction to a next focus host device based on the screen position relationship when the target image moves across a first screen edge of the host device, and the first screen edge is close to the next focus host device, where the switching instruction is used to switch to the next focus host device to display the target image, and the next focus host device is a host device that is among the at least one other host device and that is close to the first screen edge of the host device.

Steps 410: The input device sends second sending data to the plurality of host devices, where the second sending data includes second input device data, and the second input device data is used to enable the next focus host device to display the target image.

Step 412: The host device receives second receiving data sent by the input device, determines, based on the second receiving data and the screen position relationship, that the host device is a non-next focus host device, and skips displaying the target image.

In the technical solution of the data display method provided in this embodiment of the present disclosure, the input device is wirelessly connected to the plurality of host devices, and the plurality of host devices are wirelessly connected to each other. The host device obtains the screen position relationship between the host device and the at least one other host device. The input device sends the first sending data to the plurality of host devices, where the first sending data includes the first input device data. The host device receives the data sent by the input device, determines, based on the data and the screen position relationship, that the host device is the focus host device, and displays the target image corresponding to the first input device data. The host device sends the switching instruction to the next focus host device based on the screen position relationship when the target image moves across the first screen edge of the host device, and the first screen edge is close to the next focus host device. The switching instruction is used to switch to the next focus host device to display the target image. The input device sends the second sending data to the plurality of host devices. The second sending data includes the second input device data, and the second input device data is used to enable the next focus host device to display the target image corresponding to the second input device data. The host device receives the second receiving data sent by the input device, determines, based on the second receiving data and the screen position relationship, that the host device is the non-next focus host device, and skips displaying the target image. The input device keeps connected to the plurality of host devices at the same time, and link disconnection and establishment are not required, thereby reducing a switching delay.

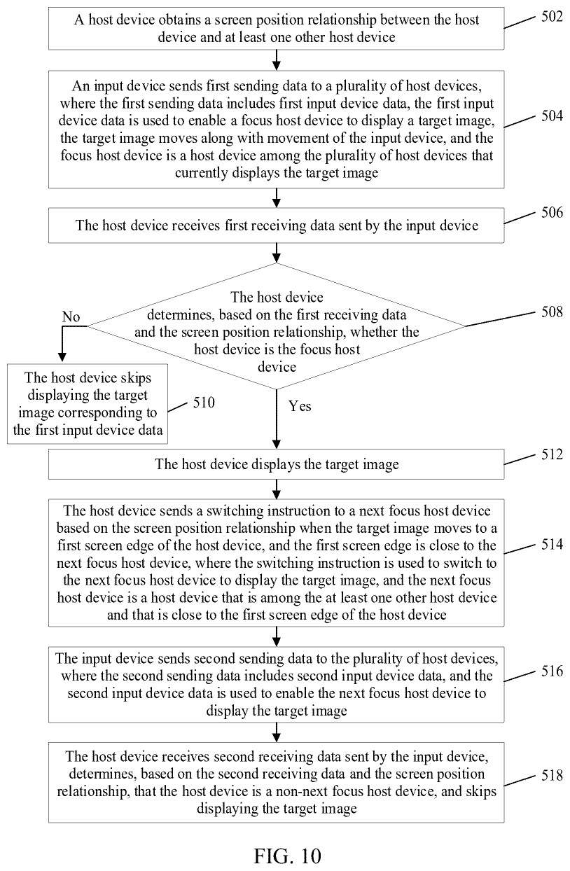

Based on system architectures shown in FIG. 6 to FIG. 8, an embodiment of the present disclosure provides another data display method. FIG. 10 is a flowchart of another data display method according to an embodiment of the present disclosure. As shown in FIG. 10, the method includes the following steps.

Step 502: A host device obtains a screen position relationship between the host device and at least one other host device.

In this embodiment of the present disclosure, the host device is wirelessly connected to the at least one other host device, and both the host device and the at least one other host device are wirelessly connected to an input device. When a quantity of other host devices is greater than or equal to 2, the at least one other host device is wirelessly connected to each other.

For example, the input device includes a mouse, a touchpad, a trackball, or an eye recognition apparatus.

For example, the host device includes a screen.

Step 504: The input device sends first sending data to a plurality of host devices, where the first sending data includes first input device data, the first input device data is used to enable a focus host device to display a target image, the target image moves along with movement of the input device, and the focus host device is a host device among the plurality of host devices that currently displays the target image.

Optionally, there are wireless connections of a plurality of one-to-one links between the input device and the plurality of host devices. The wireless connections of the plurality of one-to-one links are BLUETOOTH. The input device serves as a master, or a host device for each one-to-one link serves as a master.

The input device serves as a master. Before step 504, the data display method further includes that the input device allocates a first air interface slot to a host device that is the first to establish a connection to the input device, and allocates air interface slots to the rest of the host devices based on the first air interface slot. In this way, an air interface slot used by each of the plurality of host devices to perform wireless transmission with the input device is different from each other, so that a slot conflict that may exist between the plurality of one-to-one links can be avoided.

The host device for each one-to-one link serves as a master. Step 504 further includes that the input device sends, based on an air interface slot allocated by a host device that is the first to establish a connection to the input device, data to the host device that is the first to establish a connection to the input device, and sends data to the rest of the host devices based on air interface slots allocated to the rest of the host devices by the host device that is the first to establish a connection to the input device. In this way, an air interface slot used by each of the plurality of host devices to perform wireless transmission with the input device is different from each other, so that a slot conflict that may exist between the plurality of one-to-one links can be avoided.

A first focus host device is usually the host device that is the first to establish a connection to the input device.

A link between the input device and the focus host device is in an active state, and a link between the input device and a non-focus host device is in a keepalive state. The first sending data further includes null packet data. Step 504 further includes that the input device sends the first input device data to the focus host device, and sends the null packet data to the non-focus host device.

Optionally, there is a wireless connection of a one-to-many link between the input device and the plurality of host devices. The wireless connection of the one-to-many link includes BLUETOOTH or SPARKLINK. The first sending data is first input device data. Data sent by the input device and received by each host device is the first input device data. Before step 504, the input device selects one host device from the plurality of host devices as the first focus host device.

Step 506: The host device receives first receiving data sent by the input device.

Optionally, there are wireless connections of a plurality of one-to-one links between the input device and the plurality of host devices. If the host device is the focus host device, the first receiving data is the first input device data. If the host device is the non-focus host device, the first receiving data is the null packet data.

Optionally, there is a wireless connection of a one-to-many link between the input device and the plurality of host devices. The first sending data is the first input device data. The data sent by the input device and received by each host device is the first input device data.

Step 508: The host device determines, based on the first receiving data and the screen position relationship, whether the host device is the focus host device; and if the host device is not the focus host device, performs step 510; or if the host device is the focus host device, performs step 512.

Optionally, there are wireless connections of a plurality of one-to-one links between the input device and the plurality of host devices. The host device can determine, based on the first receiving data, whether the host device is the focus host device. Specifically, if the first receiving data is the null packet data, it is determined that the host device is the non-focus host device; or if the first receiving data is the first input data, it is determined that the host device is the focus host device.

Optionally, there is a wireless connection of a one-to-many link between the input device and the plurality of host devices. Each host device receives the same first receiving data, that is, the first input data. Therefore, coordinates of the displayed target image further need to be determined with reference to the screen position relationship, and whether the coordinates are located on the screen of the host device is determined. If the coordinates are located on the screen of the host device, it is determined that the host device is the focus host device. If the coordinates are not located on the screen of the host device, it is determined that the host device is the non-focus host device.

Step 510: The host device skips displaying the target image corresponding to the first input device data.

If the host device determines that the host device is the non-focus host device and skips displaying the target image, the focus host device is a host device that is among the at least one other host device and that currently displays the target image.

Step 512: The host device displays the target image.

If the host device determines that the host device is the focus host device and displays the target image, the at least one other host device is the non-focus host device.

Step 514: The host device sends a switching instruction to a next focus host device based on the screen position relationship when the target image moves across a first screen edge of the host device, and the first screen edge is close to the next focus host device, where the switching instruction is used to switch to the next focus host device to display the target image, and the next focus host device is a host device that is among the at least one other host device and that is close to the first screen edge of the host device.

Optionally, there are wireless connections of a plurality of one-to-one links between the input device and the plurality of host devices. After the next focus host device receives the switching instruction, the next focus host device sends an activation message to the input device. The activation message is used to enable the input device to switch a link between the input device and the next focus host device from the keepalive state to the active state, and switch the link between the input device and the focus host device from the active state to the keepalive state.

Optionally, there is a wireless connection of a one-to-many link between the input device and the plurality of host devices. The next focus host device does not need to send an activation message to the input device after receiving the switching instruction.

Step 516: The input device sends second sending data to the plurality of host devices, where the second sending data includes second input device data, and the second input device data is used to enable the next focus host device to display the target image.

Optionally, there are wireless connections of a plurality of one-to-one links between the input device and the plurality of host devices. The second sending data further includes the null packet data. Step 504 further includes that the input device sends the second input device data to the focus host device, and sends the null packet data to the non-focus host device. When the host device is the focus host device, the second receiving data is the null packet data. When the host device is the next focus host device, the second receiving data is the second input device data.

Optionally, there is a wireless connection of a one-to-many link between the input device and the plurality of host devices. The second sending data is the second input device data. The next focus host device displays the target image based on the switching instruction and the second input device data.

Step 518: The host device receives the second receiving data sent by the input device, determines, based on the second receiving data and the screen position relationship, that the host device is a non-next focus host device, and skips displaying the target image.

In the technical solution of the data display method provided in this embodiment of the present disclosure, the host device obtains the screen position relationship between the host device and the at least one other host device. The input device sends the first sending data to the plurality of host devices, where the first sending data includes the first input device data, the first input device data is used to enable the focus host device to display the target image, the target image moves along with movement of the input device, and the focus host device is a host device among the plurality of host devices that currently displays the target image. The host device receives the first receiving data sent by the input device, determines, based on the first receiving data and the screen position relationship, whether the host device is the focus host device, and skips displaying the target image when determining that the host device is the non-focus host device, or displays the target image when determining that the host device is the focus host device. The host device sends the switching instruction to the next focus host device based on the screen position relationship when the target image moves across the first screen edge of the host device, and the first screen edge is close to the next focus host device. The switching instruction is used to switch to the next focus host device to display the target image, and the next focus host device is a host device that is among the at least one other host device and that is close to the first screen edge of the host device. The input device sends the second sending data to the plurality of host devices, where the second sending data includes the second input device data, and the second input device data is used to enable the next focus host device to display the target image. The host device receives the second receiving data sent by the input device, and skips displaying the target image. The input device keeps connected to the plurality of host devices at the same time, and link disconnection and establishment are not required, thereby reducing a switching delay.

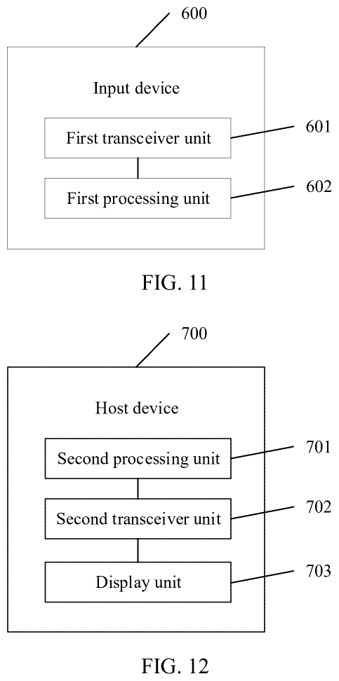

FIG. 11 is a diagram of a structure of an input device according to an embodiment of the present disclosure. It should be understood that an input device 600 can perform steps of an input device in the foregoing data display method. To avoid repetition, details are not described herein again. The input device 600 includes a first transceiver unit 601 and a first processing unit 602.

The first transceiver unit 601 is configured to send first sending data to a plurality of host devices. The first sending data includes first input device data, the first input device data is used to enable a focus host device to display a target image, the target image moves along with movement of the input device, and the focus host device is a host device among the plurality of host devices that currently displays the target image.

The first transceiver unit 601 is further configured to send second sending data to the plurality of host devices when the target image moves across a first screen edge of the focus host device, and the first screen edge is close to a next focus host device. The second sending data includes second input device data, the second input device data is used to enable the next focus host device to display the target image, and the next focus host device is a non-focus host device among the plurality of host devices that is close to the first screen edge of the focus host device.

Optionally, there are wireless connections of a plurality of one-to-one links between the input device and the plurality of host devices.

Optionally, a link between the input device and the focus host device is in an active state, and a link between the input device and a non-focus host device is in a keepalive state.

Optionally, the first sending data further includes null packet data. The first transceiver unit 601 is further configured to: send the first input device data to the focus host device, and send the null packet data to the non-focus host device; and send the second input device data to the next focus host device, and send the null packet data to the rest of the host devices.

Optionally, before the first transceiver unit 601 sends the first sending data to the plurality of host devices, the first processing unit 602 is configured to: allocate a first air interface slot to a host device that is the first to establish a connection to the input device; and allocate air interface slots to the rest of the host devices based on the first air interface slot.

Optionally, the first transceiver unit 601 further includes sending, based on an air interface slot allocated by a host device that is the first to establish a connection to the input device, data to the host device that is the first to establish a connection to the input device, and sending data to the rest of the host devices based on air interface slots allocated to the rest of the host devices by the host device that is the first to establish a connection to the input device.

Optionally, air interface slots for the plurality of host devices are different from each other.

Optionally, when the target image moves across the first screen edge of the focus host device, before the first transceiver unit 601 sends the second sending data to the plurality of host devices, the first transceiver unit 601 is further configured to receive an activation message sent by the next focus host device. The first processing unit 602 is further configured to switch, based on the activation message, a link between the input device and the next focus host device from the keepalive state to the active state, and the link between the input device and the focus host device from the active state to the keepalive state.

Optionally, the wireless connections of the plurality of one-to-one links include BLUETOOTH.

Optionally, there is a wireless connection of a one-to-many link between the input device and the plurality of host devices.

Optionally, the first transceiver unit 601 is further configured to send the first input device data to both the focus host device and the non-focus host device.

Optionally, before the first transceiver unit 601 sends the first sending data to the plurality of host devices, the first processing unit 602 is further configured to select one host device from the plurality of host devices as a first focus host device.

Optionally, the wireless connection of the one-to-many link includes BLUETOOTH or SPARKLINK.

Optionally, the input device includes a mouse, a touchpad, a trackball, or an eye recognition apparatus.

FIG. 12 is a diagram of structure of a host device according to an embodiment of the present disclosure. It should be understood that a host device 700 can perform steps of a host device in the foregoing data display method. To avoid repetition, details are not described herein again. The host device 700 includes a second processing unit 701, a second transceiver unit 702, and a display unit 703.

The second processing unit 701 is configured to obtain a screen position relationship between the host device and at least one other host device.

The second transceiver unit 702 is configured to receive first receiving data sent by the input device.

The second processing unit 701 is further configured to determine, based on the first receiving data and the screen position relationship, that the host device is a focus host device, and trigger the display unit 703 to display a target image. The focus host device is a host device among a plurality of host devices that currently displays the target image, and the target image moves along with movement of the input device.

The second transceiver unit 702 is further configured to send a switching instruction to a next focus host device based on the screen position relationship when the target image moves across a first screen edge of the host device, and the first screen edge is close to the next focus host device. The switching instruction is used to switch to the next focus host device to display the target image, and the next focus host device is a host device that is among the at least one other host device and that is close to the first screen edge of the host device.

The second transceiver unit 702 is further configured to: receive second receiving data sent by the input device, determine, based on the second receiving data and the screen position relationship, that the host device is a non-next focus host device, and skip displaying the target image.

Optionally, the second processing unit 701 is further configured to determine, based on the first receiving data and the screen position relationship, that the host device is a non-focus host device, and skip triggering the display unit 703 to display the target image. The focus host device is a host device that is among the at least one other host device and that currently displays the target image.

Optionally, there are wireless connections of a plurality of one-to-one links between the input device and the host device and the at least one other host device.

Optionally, a link between the input device and the focus host device is in an active state, and a link between the input device and a non-focus host device is in a keepalive state.

Optionally, when the host device is the focus host device, the first receiving data is first input device data, and the second receiving data is null packet data.

When the host device is the non-focus host device, the first receiving data is the null packet data.

When the host device is the next focus host device, the second receiving data is second input device data.

Optionally, the wireless connections of the plurality of one-to-one links include BLUETOOTH.

Optionally, before the second transceiver unit 702 receives the first receiving data sent by the input device, the second transceiver unit 702 is further configured to receive an air interface slot allocated by the input device. The air interface slot is different from an air interface slot allocated to the other host device by the input device.

Optionally, when the host device is a host device that is the first to establish a connection to the input device, before the second transceiver unit 702 receives the first receiving data sent by the input device, the second processing unit 701 is further configured to: allocate an air interface slot to the host device; and allocate an air interface slot to the at least one other host device based on the air interface slot.

Optionally, the air interface slot allocated to the at least one other host device is different from each other, and is different from the air interface slot.

Optionally, after the next focus host device receives the switching instruction, the next focus host device sends an activation message to the input device. The activation message is used to enable the input device to switch a link between the input device and the next focus host device from the keepalive state to the active state, and switch the link between the input device and the focus host device from the active state to the keepalive state.

Optionally, there is a wireless connection of a one-to-many link between the input device and the host device and the at least one other host device.

Optionally, the wireless connection of the one-to-many link includes BLUETOOTH or SPARKLINK.

Optionally, the first receiving data is first input device data, and the second receiving data is second input device data.

Optionally, when a quantity of other host devices is greater than or equal to 2, the at least one other host device is wirelessly connected to each other.

Optionally, the input device includes a mouse, a touchpad, a trackball, or an eye recognition apparatus.

It should be understood that the input device 600 and the host device 700 herein are embodied in a form of a functional unit. The term “unit” herein may be implemented in a form of software and/or hardware. This is not specifically limited. For example, the “unit” may be a software program, a hardware circuit, or a combination thereof for implementing the foregoing functions. The hardware circuit may include an application-specific integrated circuit (ASIC), an electronic circuit, a processor (for example, a shared processor, a dedicated processor, or a group processor) configured to execute one or more software or firmware programs, a memory, a combined logic circuit, and/or another appropriate component that supports the described functions.

Therefore, the units in the examples described in embodiments of the present disclosure can be implemented by using electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

An embodiment of this disclosure provides an electronic device. The electronic device may be a terminal device or a circuit device built into the terminal device. The electronic device may be configured to perform functions/steps in the foregoing method embodiments.

An embodiment of this disclosure provides a computer-readable storage medium. The computer-readable storage medium stores instructions. When the instructions are run on a terminal device, the terminal device is enabled to perform functions/steps in the foregoing method embodiments.

An embodiment of this disclosure further provides a computer program product including instructions. When the computer program product is run on a computer or any at least one processor, the computer is enabled to perform functions/steps in the foregoing method embodiments.

In embodiments of this disclosure, “at least one” means one or more, and “a plurality of” means two or more. The term “and/or” describes an association relationship between associated objects and indicates that three relationships may exist. For example, A and/or B may represent the following cases: only A exists, both A and B exist, and only B exists. A and B may be singular or plural. The character “/” usually indicates an “or” relationship between the associated objects. “At least one of the following” and a similar expression thereof mean any combination of these terms, including a single item or any combination of plural items. For example, at least one of a, b, and c may indicate a, b, c, a and b, a and c, b and c, or a, b, and c, where a, b, and c may be singular or plural.

A person of ordinary skill in the art may be aware that, with reference to embodiments disclosed in this specification, described units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this disclosure, when any of the functions is implemented in a form of a software functional unit and sold or used as an independent product, the functions may be stored in a computer-readable storage medium. Based on such an understanding, the technical solutions of this disclosure may be implemented in a form of a software product. The computer software product is stored in a storage medium, and includes several instructions for instructing an electronic device (which may be a personal computer, a server, or a network device) to perform all or some of the steps of the methods described in embodiments of this disclosure. The foregoing storage medium includes any medium that can store program code, such as a USB flash drive, a removable hard disk, a read-only memory (ROM), a random-access memory (RAM), a magnetic disk, or an optical disc.

The foregoing descriptions are merely specific implementations of this disclosure. Any variation or replacement readily figured out by a person skilled in the art within the technical scope disclosed in this disclosure shall fall within the protection scope of this disclosure. The protection scope of this disclosure shall be subject to the protection scope of the claims.

1. A method applied to an input device, wherein the method comprises:
sending first sending data to a plurality of host devices, wherein the first sending data comprises first input device data, wherein the first input device data enables a first focus host device of the plurality of host devices to display a target image moving along with movement of the input device; and
sending, when the target image moves across a first screen edge of the first focus host device and when the first screen edge is near a second focus host device of the plurality of host devices, second sending data to the plurality of host devices,
wherein the second sending data comprises second input device data, and
wherein the second input device data enables the second focus host device to display the target image.

2. The method of claim 1, wherein a first link between the input device and the first focus host device is in an active state, wherein a second link between the input device and a non-focus host device of the plurality of host devices is in a keepalive state, and wherein the first link and the second link are wireless connections of a plurality of one-to-one links between the input device and the plurality of host devices.

3. The method of claim 2, wherein the first sending data further comprises null packet data, and wherein sending the first sending data to the plurality of host devices comprises:
sending the first input device data to the first focus host device; and
sending the null packet data to a non-focus host device, of the plurality of host devices, and
wherein sending the second sending data to the plurality of host devices comprises:
sending the second input device data to the second focus host device; and
sending the null packet data to the host devices other than the second focus host device.

4. The method of claim 2, wherein before sending first sending data to the plurality of host devices, the method further comprises:
allocating a first air interface slot to a first host device that is first to establish a connection to the input device; and
allocating, based on the first air interface slot, air interface slots to the host devices other than the first host device.

5. The method of claim 2, wherein sending the first sending data to the plurality of host devices comprises:
sending, based on an air interface slot allocated by a first host device that is first to establish a connection to the input device, first data to the first host device; and
sending second data to the host devices other than the first host device based on air interface slots allocated to the host devices other than the first host device.

6. The method of claim 2, wherein when the target image moves across the first screen edge of the focus host device and before sending the second sending data to the plurality of host devices, the method further comprises:
receiving an activation message from the second focus host device; and
switching, based on the activation message, a first link between the input device and the second focus host device from the keepalive state to the active state, and second link between the input device and the first focus host device from the active state to the keepalive state.

7. The method of claim 1, wherein sending the first sending data to the plurality of host devices comprises sending the first input device data to the first focus host device and a non-focus host device of the plurality of host devices.

8. The method of claim 1, wherein before sending the first sending data to the plurality of host devices, the method further comprises selecting one host device from the plurality of host devices as the first focus host device.

9. A data display method, applied to a host device, wherein the method comprises:
receiving, from an input device, first receiving data;
determining, based on the first receiving data and a screen position relationship between the host device and at least one other host device, that the host device is a first focus host device, that currently displays a target image that moves along with movement of an input device;
sending a switching instruction to a second focus host device of the at least one other host device based on the screen position relationship when the target image moves across a first screen edge of the host device and when the first screen edge is near the second focus host device, wherein the switching instruction instructs to switch to the second focus host device to display the target image;
receiving, from the input device, second receiving data;
determining, based on the second receiving data and the screen position relationship, that the host device is a non-focus host device; and
not displaying the target image.

10. The method of claim 9, further comprising:
determining, based on the first receiving data and the screen position relationship, that the host device is a non-focus host device; and
not displaying the target image.

11. The method of claim 9, wherein a first link between the input device and the first focus host device is in an active state, wherein a second link between the input device and the non-focus host device is in a keepalive state, and wherein the first link and the second link are wireless connections of a plurality of one-to-one links between the input device and the at least one other host device.

12. The method of claim 9, wherein when the host device is the first focus host device, the first receiving data is first input device data and the second receiving data is null packet data, wherein when the host device is a non-focus host device, the first receiving data is the null packet data, and wherein when the host device is the second focus host device, the second receiving data is second input device data.

13. An input device comprising:
a memory configured to store instructions; and
one or more processors coupled to the memory, wherein the instructions, when executed by the one or more processors, cause the input device to:
send first sending data to a plurality of host devices, wherein the first sending data comprises first input device data, wherein the first input device data enables a first focus host device of the plurality of host devices to display a target image moving along with movement of the input device; and
send, when the target image moves across a first screen edge of the first focus host device and when the first screen edge is near a second focus host device of the plurality of host devices, second sending data to the plurality of host devices,
wherein the second sending data comprises second input device data, and
wherein the second input device data enables the second focus host device to display the target image.

14. The input device of claim 13, wherein a first link between the input device and the first focus host device is in an active state, wherein a second link between the input device and a non-focus host device is in a keepalive state, and wherein the first link and the second link are wireless connections of a plurality of one-to-one links between the input device and the plurality of host devices.

15. The input device of claim 14, wherein the first sending data further comprises null packet data, and wherein the instructions, when executed by the one or more processors, further cause the input device to:
further send the first sending data to the plurality of host devices by:
sending the first input device data to the first focus host device; and
sending the null packet data to a non-focus host device of the plurality of host devices; and
further send the second sending data to the plurality of host devices by:
sending the second input device data to the second focus host device; and
sending the null packet data the host devices other than the second focus host device.

16. The input device of claim 14, wherein before causing the input device to send first sending data to the plurality of host devices, the instructions, when executed by the one or more processors, further cause the input device to:
allocate a first air interface slot to a first host device that is first to establish a connection to the input device; and
allocate, based on the first air interface slot, air interface slots to the host devices other than the first host device based on the first air interface slot, wherein air interface slots for the plurality of host devices are different from each other.

17. The input device of claim 14, wherein the instructions, when executed by the one or more processors, further cause the input device to further send the first sending data to the plurality of host devices by:
sending, based on an air interface slot allocated by a first host device that is first to establish a connection to the input device, first data to the first host device; and
sending second data to the host devices other than the first host device based on air interface slots allocated to the host devices other than the first host device.

18. The input device of claim 14, wherein when the target image moves across the first screen edge of the focus host device and before sending the second sending data to the plurality of host devices, the instructions, when executed by the one or more processors, further cause the input device to:
receive an activation message from the second focus host device; and
switch, based on the activation message, a first link between the input device and the second focus host device from the keepalive state to the active state, and a second link between the input device and the first focus host device from the active state to the keepalive state.

19. The input device of claim 13, further comprising a wireless connection of a one-to-many link between the input device and the plurality of host devices, and wherein the instructions, when executed by the one or more processors, further cause the input device to further send the first sending data to the plurality of host devices by sending the first input device data to both the first focus host device and a non-focus host device of the plurality of host devices.

20. The input device of claim 19, wherein before sending the first sending data to the plurality of host devices, the instructions, when executed by the one or more processors, further cause the input device to select one host device from the plurality of host devices as the first focus host device.
